(19) United States
(12) Patent Application Publication
(10) Pub. No.: US 2023/0145269 A1
(43) Pub. Date: May 11, 2023

(54) PIXEL OF DISPLAY APPARATUS

(71) Applicant: Samsung Display Co., LTD., Yongin-si (KR)

(72) Inventors: Kyonghwan OH, Seoul (KR); Chulkyu KANG, Suwon-si (KR); Jintae JEONG, Suwon-si (KR); Kimyeong EOM, Suwon-si (KR); Jaehoon LEE, Seoul (KR); Soon-Gi KWON, Suwon-si (KR); Yangwan KIM, Hwaseong-si (KR); Minku LEE, Asan-si (KR)

(73) Assignee: Samsung Display Co., LTD., Yongin-si (KR)

(21) Appl. No.: 17/979,975

(22) Filed: Nov. 3, 2022

(30) Foreign Application Priority Data
Nov. 5, 2021 (KR) 10-2021-0151682

(51) Int. Cl. G09G 3/20

(52) U.S. Cl. CPC G09G 3/20; G09G 2300/0819; G09G 2300/0852; G09G 2300/0426

(57) ABSTRACT

A pixel of a display apparatus includes a light emitting element, a first transistor, a second transistor, a first capacitor, and a second capacitor. The first transistor applies a driving current to the light emitting element. The second transistor transmits a data voltage. The first capacitor includes a first end electrically connected to a control electrode of the first transistor, and a second end electrically connected to an output electrode of the second transistor. The second capacitor includes a first end electrically connected to the output electrode of the second transistor, and a second end electrically connected to an output electrode of the first transistor.

### CROSS REFERENCE TO RELATED APPLICATION(S)

This application claims priority to and benefits of Korean Patent Application No. 10-2021-0151682 under 35 U.S.C. § 119, filed on Nov. 5, 2021, in the Korean Intellectual Property Office (KIPO), the entire contents of which are incorporated herein by reference in their entireties.

### BACKGROUND

### 1. Technical Field

Embodiments of the disclosure relate to a pixel of a display apparatus. More specifically, embodiments of the disclosure relate to a pixel of a display apparatus enhancing a compensating ability of a threshold voltage of a driving transistor to enhance a display quality.

### 2. Description of the Related Art

Generally, a display apparatus includes a display panel and a display panel driver. The display panel includes gate lines, data lines, emission lines and pixels. The display panel driver includes a gate driver, a data driver, an emission driver and a driving controller. The gate driver outputs gate signals to the gate lines. The data driver outputs data voltages to the data lines. The emission driver outputs emission signals to the emission lines. The driving controller controls the gate driver, the data driver and the emission driver.

In a conventional pixel circuit, an anode electrode of a light emitting element is formed as a source electrode of a driving transistor, and a source voltage of the driving transistor changes to a light emitting voltage of the light emitting element. In case that the source voltage of the driving transistor changes to the light emitting voltage of the light emitting element, the threshold voltage stored in a storage capacitor may be lost so that the compensating ability of the threshold voltage may be decreased.

In case that a capacitance of the storage capacitor is increased to enhance the compensating ability of the threshold voltage, a resolution and a layout may be limited.

It is to be understood that this background of the technology section is, in part, intended to provide useful background for understanding the technology. However, this background of the technology section may also include ideas, concepts, or recognitions that were not part of what was known or appreciated by those skilled in the pertinent art prior to a corresponding effective filing date of the subject matter disclosed herein.

### SUMMARY

Embodiments of the disclosure provide a pixel of a display apparatus capable of enhancing a display quality of a display panel.

In an embodiment of a pixel of a display apparatus according to the disclosure, the pixel includes a light emitting element, a first transistor, a second transistor, a first capacitor and a second capacitor. The first transistor applies a driving current to the light emitting element. The second transistor transmits a data voltage. The first capacitor includes a first end electrically connected to a control electrode of the first transistor, and a second end electrically connected to an output electrode of the second transistor. The second capacitor includes a first end electrically connected to the output electrode of the second transistor, and a second end electrically connected to an output electrode of the first transistor.

In an embodiment, the pixel may further include a third transistor including a control electrode that receives a compensation gate signal, an input electrode electrically connected to an input electrode of the first transistor, and an output electrode electrically connected to the control electrode of the first transistor.

In an embodiment, the pixel may further include a fourth transistor including a control electrode that receives a second initialization gate signal, an input electrode that receives an initialization voltage, and an output electrode electrically connected to a first electrode of the light emitting element, and a fifth transistor including a control electrode that receives a first initialization gate signal, an input electrode the receives a second initialization voltage and an output electrode electrically connected to the output electrode of the second transistor.

In an embodiment, the pixel may further include a sixth transistor including a control electrode that receives a reference gate signal, an input electrode that receives a reference voltage, and an output electrode electrically connected to the control electrode of the first transistor and a seventh transistor including a control electrode that receives an emission signal, an input electrode that receives a first power voltage, and an output electrode electrically connected to the input electrode of the first transistor.

In an embodiment, the first to seventh transistors may be N-type transistors.

In an embodiment, the first transistor may include the control electrode, an input electrode, the output electrode and a second control electrode. The second control electrode of the first transistor may be electrically connected to the output electrode of the first transistor.

In an embodiment, the first transistor may include the control electrode, an input electrode, the output electrode and a second control electrode. A bias voltage may be applied to the second control electrode of the first transistor.

In an embodiment, the first transistor may include the control electrode, an input electrode, the output electrode and a second control electrode. The pixel may further include an eighth transistor including a control electrode that receives a compensation gate signal, an input electrode that receives a bias voltage, and an output electrode electrically connected to the second control electrode of the first transistor and a third capacitor including a first end electrically connected to the second control electrode of the first transistor, and a second end electrically connected to the output electrode of the first transistor.

In an embodiment, the pixel may further include a fourth transistor including a control electrode that receives a second initialization gate signal, an input electrode that receives an initialization voltage, and an output electrode electrically connected to a first electrode of the light emitting element, and a fifth transistor including a control electrode that receives a first initialization gate signal, an input electrode electrically connected to the output electrode of the fourth transistor, and an output electrode electrically connected to the output electrode of the second transistor.

In an embodiment, the pixel may further include a fourth transistor including a control electrode that receives a second initialization gate signal, an input electrode that receives an initialization voltage, and an output electrode electrically connected to a first electrode of the light emitting element, and a fifth transistor including a control electrode that receives a first initialization gate signal, an input electrode that receives the initialization voltage, and an output electrode electrically connected to the output electrode of the second transistor.

In an embodiment of a pixel of a display apparatus according to the disclosure, the pixel includes the pixel includes a light emitting element, a first transistor, a second transistor, a first capacitor and a second capacitor. The first transistor applies a driving current to the light emitting element. The second transistor transmits a data voltage. The first capacitor includes a first end electrically connected to a control electrode of the first transistor, and a second end electrically connected to an output electrode of the first transistor. The second capacitor includes a first end electrically connected to an output electrode of the second transistor, and a second end electrically connected to the control electrode of the first transistor.

In an embodiment, the pixel may further include a third transistor including a control electrode that receives a compensation gate signal, an input electrode electrically connected to an input electrode of the first transistor, and an output electrode electrically connected to the control electrode of the first transistor.

In an embodiment, the pixel may further include a fourth transistor including a control electrode that receives a second initialization gate signal, an input electrode that receives an initialization voltage, and an output electrode electrically connected to a first electrode of the light emitting element, and a fifth transistor including a control electrode that receives a first initialization gate signal, an input electrode that receives a second initialization voltage, and an output electrode electrically connected to the output electrode of the second transistor.

In an embodiment, the pixel may further include a sixth transistor including a control electrode that receives a reference gate signal, an input electrode that receives a reference voltage, and an output electrode electrically connected to the control electrode of the first transistor, and a seventh transistor including a control electrode that receives an emission signal, an input electrode that receives a first power voltage, and an output electrode electrically connected to the input electrode of the first transistor.

In an embodiment, the first to seventh transistors may be N-type transistors.

In an embodiment, the first transistor may include the control electrode, an input electrode, the output electrode and a second control electrode. The second control electrode of the first transistor may be electrically connected to the output electrode of the first transistor.

In an embodiment, the first transistor may include the control electrode, an input electrode, the output electrode and a second control electrode. A bias voltage may be applied to the second control electrode of the first transistor.

In an embodiment, the first transistor may include the control electrode, an input electrode, the output electrode and a second control electrode. The pixel may further include an eighth transistor including a control electrode that receives a compensation gate signal, an input electrode that receives a bias voltage, and an output electrode electrically connected to the second control electrode of the first transistor, and a third capacitor including a first end electrically connected to the second control electrode of the first transistor, and a second end electrically connected to the output electrode of the first transistor.

In an embodiment, the pixel may further include a fourth transistor including a control electrode that receives a second initialization gate signal, an input electrode that receives an initialization voltage, and an output electrode electrically connected to a first electrode of the light emitting element, and a fifth transistor including a control electrode that receives a first initialization gate signal, an input electrode that receives the initialization voltage, and an output electrode electrically connected to the output electrode of the second transistor.

In an embodiment, the pixel may further include a fourth transistor including a control electrode that receives a second initialization gate signal, an input electrode that receives an initialization voltage, and an output electrode electrically connected to a first electrode of the light emitting element, and a fifth transistor including a control electrode that receives a first initialization gate signal, an input electrode that receives a first power voltage, and an output electrode electrically connected to the output electrode of the second transistor.

In an embodiment of a pixel of a display apparatus according to the disclosure, the pixel includes a first transistor including a control electrode electrically connected to a first node, an input electrode electrically connected to a second node, an output electrode electrically connected to a third node, and a second control electrode electrically connected to an output electrode of an eighth transistor, a second transistor including a control electrode that receives a writing gate signal, an input electrode that receives a data voltage, and an output electrode electrically connected to the third node, a third transistor including a control electrode that receives the writing gate signal, an input electrode electrically connected to the second node, and an output electrode electrically connected to the first node, a fourth transistor including a control electrode that receives an initialization gate signal, an input electrode that receives an initialization voltage, and an output electrode electrically connected to a first electrode of a light emitting element, a fifth transistor including a control electrode that receives an emission signal, an input electrode that receives a first power voltage, and an output electrode electrically connected to the second node, a sixth transistor including a control electrode that receives the emission signal, an input electrode electrically connected to the third node, and an output electrode electrically connected to the first electrode of the light emitting element, a seventh transistor including a control electrode that receives a reference gate signal, an input electrode that receives a reference voltage, and an output electrode electrically connected to the first node, the eighth transistor including a control electrode that receives a bias gate signal, an input electrode that receives a bias voltage, and the output electrode electrically connected to the second control electrode of the first transistor and the light emitting element including the first electrode electrically connected to the output electrode of the sixth transistor, and a second electrode that receives a second power voltage.

In an embodiment, the pixel may further include a first capacitor including a first end electrically connected to the first node, and a second end electrically connected to the first electrode of the light emitting element, and a second capacitor including a first end electrically connected to the output electrode of the eighth transistor, and a second end electrically connected to the first electrode of the light emitting element.

In an embodiment, the first to eighth transistor may be N-type transistors.

According to the pixel of the display apparatus, the pixel includes two capacitors connected in series between the control electrode of the driving transistor and the output electrode of the driving transistor or the pixel includes a first capacitor disposed between the control electrode of the driving transistor and the output electrode of the driving transistor and a second capacitor disposed between the control electrode of the driving transistor and the output electrode of the writing transistor so that the compensating ability of the threshold voltage of the driving transistor may be enhanced.

The compensating ability of the threshold voltage of the driving transistor is enhanced so that the display quality of the display panel may be enhanced.

### BRIEF DESCRIPTION OF THE DRAWINGS

The above and other features and advantages of the disclosure will become more apparent by describing in detailed embodiments thereof with reference to the accompanying drawings, in which:

FIG. 1 is a schematic block diagram illustrating a display apparatus according to an embodiment of the disclosure;

FIG. 2 is a schematic diagram of an equivalent circuit illustrating a pixel of a display panel of FIG. 1;

FIG. 3 is a schematic timing diagram illustrating input signals applied to the pixel of FIG. 2;

FIG. 4 is a schematic diagram of an equivalent circuit illustrating a pixel of a display panel of a display apparatus according to an embodiment of the disclosure;

FIG. 5 is a schematic diagram of an equivalent circuit illustrating a pixel of a display panel of a display apparatus according to an embodiment of the disclosure;

FIG. 6 is a schematic diagram of an equivalent circuit illustrating a pixel of a display panel of a display apparatus according to an embodiment of the disclosure;

FIG. 7 is a schematic diagram of an equivalent circuit illustrating a pixel of a display panel of a display apparatus according to an embodiment of the disclosure;

FIG. 8 is a schematic diagram of an equivalent circuit illustrating a pixel of a display panel of a display apparatus according to an embodiment of the disclosure;

FIG. 9 is a schematic diagram of an equivalent circuit illustrating a pixel of a display panel of a display apparatus according to an embodiment of the disclosure;

FIG. 10 is a schematic timing diagram illustrating input signals applied to the pixel of FIG. 9;

FIG. 11 is a schematic diagram of an equivalent circuit illustrating a pixel of a display panel of a display apparatus according to an embodiment of the disclosure;

FIG. 12 is a schematic diagram of an equivalent circuit illustrating a pixel of a display panel of a display apparatus according to an embodiment of the disclosure;

FIG. 13 is a schematic diagram of an equivalent circuit illustrating a pixel of a display panel of a display apparatus according to an embodiment of the disclosure;

FIG. 14 is a schematic timing diagram illustrating input signals applied to a pixel of a display panel of a display apparatus according to an embodiment of the disclosure;

FIG. 15 is a schematic timing diagram illustrating input signals applied to a pixel of a display panel of a display apparatus according to an embodiment of the disclosure; and

FIG. 16 is a schematic diagram of an equivalent circuit illustrating a pixel of a display panel of a display apparatus according to an embodiment of the disclosure.

### DETAILED DESCRIPTION OF THE EMBODIMENTS

Hereinafter, the disclosure will be explained in detail with reference to the accompanying drawings.

It will be understood that the terms “comprise,” “include,” “have,” and the like, when used in this specification, specify the presence of stated features, integers, steps, operations, elements, components, and/or combinations of them but do not preclude the presence or addition of one or more other features, integers, steps, operations, elements, components, and/or combinations thereof. Furthermore, when a first part such as a layer, a film, a region, or a plate is disposed on a second part, the first part may be not only directly on the second part, but a third part may intervene therebetween. When it is expressed that a first part such as a layer, a film, a region, or a plate is formed (or disposed) on a second part, the surface of the second part on which the first part is formed is not limited to an upper surface of the second part but may include other surfaces such as a side surface or a lower surface of the second part. To the contrary, when a first part such as a layer, a film, a region, or a plate is under a second part, the first part may be directly under the second part and a third part may intervene be interposed between them.

It will be understood that the terms “contact,” “connected to,” and “coupled to” may include a physical and/or electrical contact, connection, or coupling.

The phrase “at least one of” is intended to include the meaning of “at least one selected from the group of” for the purpose of its meaning and interpretation. For example, “at least one of A and B” may be understood to mean “A, B, or A and B.”

The term “and/or” includes all combinations of one or more of which associated configurations may define. For example, “A and/or B” may be understood to mean “A, B, or A and B.”

Unless otherwise defined or implied herein, all terms (including technical and scientific terms) used herein have the same meaning as commonly understood by those skilled in the art to which this disclosure pertains. It will be further understood that terms, such as those defined in commonly used dictionaries, should be interpreted as having a meaning that is consistent with their meaning in the context of the relevant art and the disclosure, and should not be interpreted in an ideal or excessively formal sense unless clearly so defined herein.

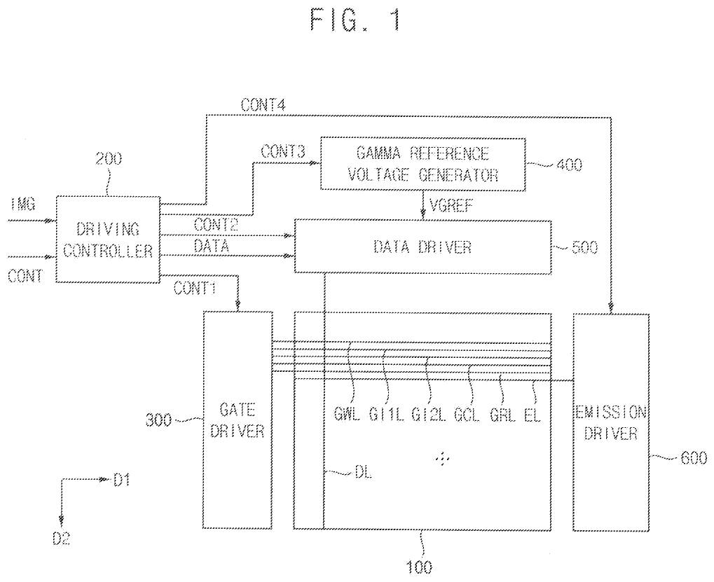

FIG. 1 is a schematic block diagram illustrating a display apparatus according to an embodiment of the disclosure.

Referring to FIG. 1, the display apparatus includes a display panel 100 and a display panel driver. The display panel driver includes a driving controller 200, a gate driver 300, a gamma reference voltage generator 400, a data driver 500, and an emission driver 600.

The display panel 100 has a display region on which an image is displayed and a peripheral region adjacent to the display region.

The display panel 100 includes gate lines GWL, GI1L, GI2L, GCL, and GRL, data lines DL, emission lines EL and pixels electrically connected to the gate lines GWL, GI1L, GI2L, GCL, and GRL, the data lines DL, and the emission lines EL. The gate lines GWL, GI1L, GI2L, GCL, and GRL may extend in a first direction D1, the data lines DL may extend in a second direction D2 intersecting the first direction D1, and the emission lines EL may extend in the first direction D1.

The driving controller 200 receives input image data IMG and an input control signal CONT from an external apparatus. For example, the input image data IMG may include red image data, green image data, and blue image data. The input image data IMG may include white image data. The input image data IMG may include magenta image data, cyan image data, and yellow image data. The input control signal CONT may include a master clock signal and a data enable signal. The input control signal CONT may further include a vertical synchronizing signal and a horizontal synchronizing signal.

The driving controller 200 generates a first control signal CONT1, a second control signal CONT2, a third control signal CONT3, a fourth control signal CONT4, and a data signal DATA based on the input image data IMG and the input control signal CONT.

The driving controller 200 generates the first control signal CONT1 for controlling an operation of the gate driver 300 based on the input control signal CONT, and outputs the first control signal CONT1 to the gate driver 300. The first control signal CONT1 may include a vertical start signal and a gate clock signal.

The driving controller 200 generates the second control signal CONT2 for controlling an operation of the data driver 500 based on the input control signal CONT, and outputs the second control signal CONT2 to the data driver 500. The second control signal CONT2 may include a horizontal start signal and a load signal.

The driving controller 200 generates the data signal DATA based on the input image data IMG. The driving controller 200 outputs the data signal DATA to the data driver 500.

The driving controller 200 generates the third control signal CONT3 for controlling an operation of the gamma reference voltage generator 400 based on the input control signal CONT, and outputs the third control signal CONT3 to the gamma reference voltage generator 400.

The driving controller 200 generates the fourth control signal CONT4 for controlling an operation of the emission driver 600 based on the input control signal CONT, and outputs the fourth control signal CONT4 to the emission driver 600.

The gate driver 300 generates gate signals for driving the gate lines GWL, GI1L, GI2L, GCL, and GRL in response to the first control signal CONT1 received from the driving controller 200. The gate driver 300 may sequentially output the gate signals to the gate lines GWL, GI1L, GI2L, GCL, and GRL.

The gamma reference voltage generator 400 generates a gamma reference voltage VGREF in response to the third control signal CONT3 received from the driving controller 200. The gamma reference voltage generator 400 provides the gamma reference voltage VGREF to the data driver 500. The gamma reference voltage VGREF has a value corresponding to a level of the data signal DATA.

In an embodiment, the gamma reference voltage generator 400 may be disposed in the driving controller 200, or in the data driver 500.

The data driver 500 receives the second control signal CONT2 and the data signal DATA from the driving controller 200, and receives the gamma reference voltages VGREF from the gamma reference voltage generator 400. The data driver 500 converts the data signal DATA into data voltages of an analog type by using the gamma reference voltages VGREF. The data driver 500 outputs the data voltages to the data lines DL.

The emission driver 600 generates emission signals to drive the emission lines EL in response to the fourth control signal CONT4 received from the driving controller 200. The emission driver 600 may output the emission signals to the emission lines EL.

Although FIG. 1 illustrates that the gate driver 300 is disposed at a first side of the display panel 100 and the emission driver 600 is disposed at a second side of the display panel 100 opposite to the first side for convenience of explanation, the disclosure may not be limited thereto. For example, both of the gate driver 300 and the emission driver 600 may be disposed at the first side of the display panel 100. For example, the gate driver 300 and the emission driver 600 may be integrally formed.

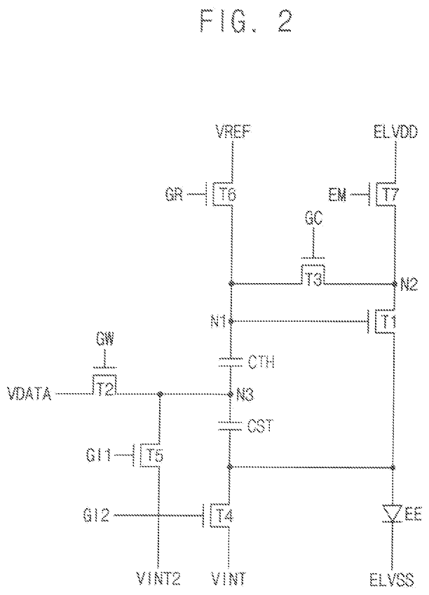

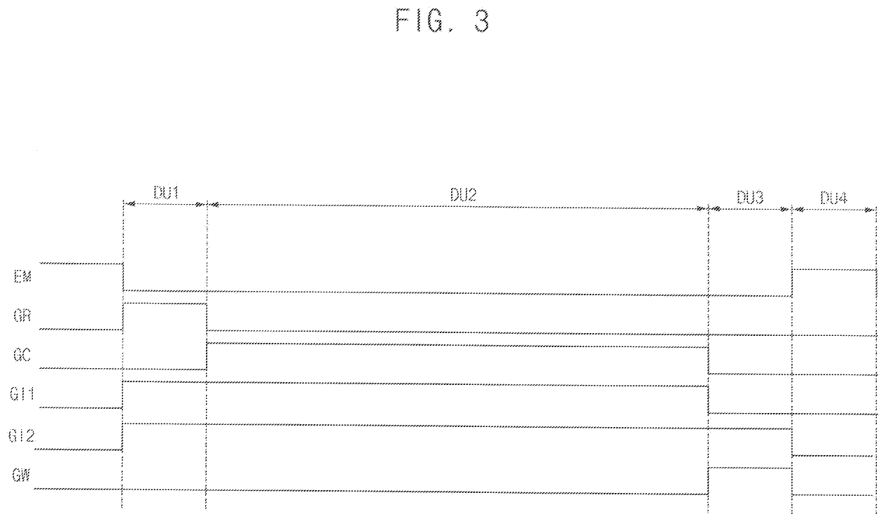

FIG. 2 is a schematic diagram of an equivalent circuit illustrating a pixel of the display panel 100 of FIG. 1. FIG. 3 is a schematic timing diagram illustrating input signals applied to the pixel of FIG. 2.

Referring to FIGS. 1 to 3, the display panel 100 includes the pixels. Each pixel includes a light emitting element EE.

The pixel receives a writing gate signal GW, a first initialization gate signal GI1, a second initialization gate signal GI2, a compensation gate signal GC, a reference gate signal GR, a data voltage VDATA, and an emission signal EM, and the light emitting element EE of the pixel emits light corresponding to the level of the data voltage VDATA to display the image.

The pixel may include the light emitting element EE, a first transistor T1, a second transistor T2, a first capacitor CTH, and a second capacitor CST. The first transistor T1 applies a driving current to the light emitting element EE. The second transistor T2 writes (transmits, or sends) the data voltage VDATA. The first capacitor CTH includes a first end connected to a control electrode (N1) of the first transistor T1 and a second end connected to an output electrode (N3) of the second transistor T2. The second capacitor CST includes a first end connected to the output electrode (N3) of the second transistor T2 and a second end connected to an output electrode of the first transistor T1.

The first transistor T1 may include a control electrode connected to a first node N1, an input electrode connected to a second node N2, and the output electrode connected to a first electrode of the light emitting element EE.

The second transistor T2 may include a control electrode receiving the writing gate signal GW, an input electrode receiving the data voltage VDATA, and the output electrode connected to a third node N3.

The light emitting element EE may include a first electrode connected to the output electrode of the first transistor T1 and a second electrode receiving a second power voltage ELVSS. For example, the first electrode of the light emitting element EE is an anode electrode, and the second electrode of the light emitting element EE is a cathode electrode.

The pixel may further include a third transistor T3 including a control electrode receiving the compensation gate signal GC, an input electrode connected to the input electrode (N2) of the first transistor T1, and an output electrode connected to the control electrode (N1) of the first transistor T1.

The pixel may further include a fourth transistor T4 including a control electrode receiving the second initialization gate signal G12, an input electrode receiving an initialization voltage VINT, and an output electrode connected to the first electrode of the light emitting element EE.

The pixel may further include a fifth transistor T5 including a control electrode receiving the first initialization gate signal GI1, an input electrode receiving a second initialization voltage VINT2, and an output electrode connected to the output electrode (N3) of the second transistor T2.

The pixel may further include a sixth transistor T6 including a control electrode receiving the reference gate signal GR, an input electrode receiving a reference voltage VREF, and an output electrode connected to the control electrode (N1) of the first transistor T1.

The pixel may further include a seventh transistor T7 including a control electrode receiving the emission signal EM, an input electrode receiving a first power voltage ELVDD, and an output electrode connected to the input electrode N2 of the first transistor T1.

For example, the first power voltage ELVDD may be greater than the second power voltage ELVSS. For example, the first power voltage ELVDD may be a high power voltage of the pixel, and the second power voltage ELVSS may be a low power voltage of the pixel.

For example, the first to seventh transistors T1 to T7 may be N-type transistors. For example, the first to seventh transistors T1 to T7 may be oxide transistors.

In a first duration DU1 of FIG. 3, the emission signal EM may have an inactive level, the reference gate signal GR may have an active level, the compensation gate signal GC may have an inactive level, the first initialization gate signal GI1 may have an active level, the second initialization gate signal GI2 may have an active level, and the writing gate signal GW may have an inactive level.

The first duration DU1 of FIG. 3 may be an initialization duration. In the first duration DU1 of FIG. 3, the fourth transistor T4 is turned on to apply the initialization voltage VINT to the second end of the second capacitor CST, and the fifth transistor T5 is turned on to apply the second initialization voltage VINT2 to the third node N3. In addition, in the first duration DU1 of FIG. 3, the sixth transistor T6 is turned on to apply the reference voltage VREF to the first node N1.

In the initialization duration DU1, the reference voltage VREF, the second initialization voltage VINT2, and the initialization voltage VINT may be respectively applied to the first node N1, the third node N3, and the anode electrode of the light emitting element EE so that the control electrode of the first transistor T1, the first capacitor CTH, the second capacitor CST, and the anode electrode of the light emitting element EE may be respectively initialized.

For example, the initialization voltage VINT may be set to be less than a sum of a threshold voltage of the light emitting element EE and the second power voltage ELVSS. The initialization voltage VINT is set to be less than the sum of the threshold voltage of the light emitting element EE and the second power voltage ELVSS so that the light emitting element EE may not emit light in the initialization duration.

For example, the initialization voltage VINT and the second power voltage ELVSS may have a same level.

For example, the reference voltage VREF may be a relatively high direct-current (DC) voltage. For example, the reference voltage VREF and the first power voltage ELVDD may have a same level.

In a second duration DU2 of FIG. 3, the emission signal EM may have the inactive level, the reference gate signal GR may have an inactive level, the compensation gate signal GC may have an active level, the first initialization gate signal GI1 may have the active level, the second initialization gate signal GI2 may have the active level, and the writing gate signal GW may have the inactive level.

The second duration DU2 of FIG. 3 may be a threshold voltage compensation duration. In the second duration DU2 of FIG. 3, the first, third, fourth, and fifth transistors T1, T3, T4, and T5 may be turned on. A component of the threshold voltage of the first transistor T1 may be stored in the first capacitor CTH through a path of the third transistor T3 and the first transistor T1.

In case that VTH is the threshold voltage of the first transistor T1, a voltage of the first electrode of the first capacitor CTH is VINT+VTH, and a voltage of the second electrode of the first capacitor CTH is VINT2, in the second duration DU2 of FIG. 3.

In a third duration DU3 of FIG. 3, the emission signal EM may have the inactive level, the reference gate signal GR may have the inactive level, the compensation gate signal GC may have the inactive level, the first initialization gate signal GI1 may have an inactive level, the second initialization gate signal GI2 may have an active level, and the writing gate signal GW may have an active level.

The third duration DU3 of FIG. 3 may be a data writing duration (or data transmission duration). In the third duration DU3 of FIG. 3, the first, second, and fourth transistors T1, T2, and T4 may be turned on. The data voltage VDATA may be written at the third node N3 through the second transistor T2. In this case, the voltage of the control electrode of the first transistor T1 may be VINT+VTH+(DATA−VINT2).

In a fourth duration DU4 of FIG. 3, the emission signal EM may have the active level, the reference gate signal GR may have the inactive level, the compensation gate signal GC may have the inactive level, the first initialization gate signal GI1 may have an inactive level, the second initialization gate signal GI2 may have an inactive level, and the writing gate signal GW may have the inactive level.

The fourth duration DU4 of FIG. 3 may be a light emitting duration. In the fourth duration DU4 of FIG. 3, the first and seventh transistors T1 and T7 may be turned on. The light emitting element EE may emit light by a current flowing through the seventh transistor T7, the first transistor T1, and the light emitting element EE. A luminance of the light emitting element EE may be determined by a voltage of the control electrode of the first transistor T1.

According to the embodiment, the pixel includes two capacitors CTH and CST connected in series between the control electrode of a driving transistor T1 and the output electrode of the driving transistor T1 so that the compensating ability of the threshold voltage VTH of the driving transistor T1 may be enhanced.

The compensating ability of the threshold voltage VTH of the driving transistor T1 is enhanced so that the display quality of the display panel 100 may be enhanced.

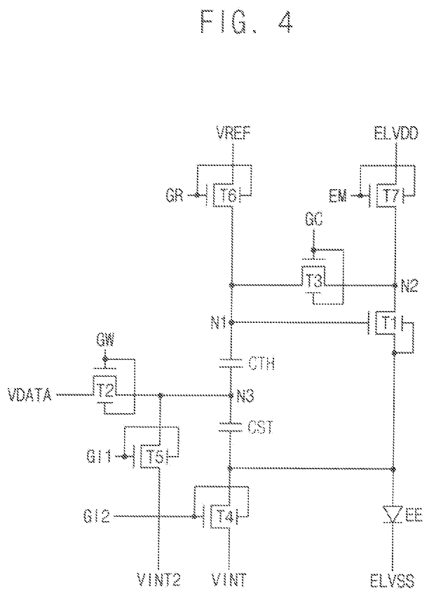

FIG. 4 is a schematic diagram of an equivalent circuit illustrating a pixel of a display panel of a display apparatus according to an embodiment of the disclosure.

The display apparatus according to the embodiment is substantially the same as the display apparatus of the previous embodiment explained referring to FIGS. 1 to 3 except for the pixel structure. Thus, the same reference numerals will be used to refer to the same or like parts as those described in the previous embodiment of FIGS. 1 to 3 and any repetitive explanation concerning the above elements will be omitted.

Referring to FIGS. 1, 3, and 4, the display panel 100 includes the pixels. Each pixel includes a light emitting element EE.

The pixel receives a writing gate signal GW, a first initialization gate signal GI1, a second initialization gate signal GI2, a compensation gate signal GC, a reference gate signal GR, the data voltage VDATA, and the emission signal EM, and the light emitting element EE of the pixel emits light corresponding to the level of the data voltage VDATA to display the image.

The pixel may include the light emitting element EE, a first transistor T1, a second transistor T2, a first capacitor CTH, and a second capacitor CST. The first transistor T1 applies a driving current to the light emitting element EE. The second transistor T2 writes the data voltage VDATA. The first capacitor CTH includes a first end connected to a control electrode (N1) of the first transistor T1 and a second end connected to an output electrode (N3) of the second transistor T2. The second capacitor CST includes a first end connected to the output electrode (N3) of the second transistor T2 and a second end connected to an output electrode of the first transistor T1.

The first transistor T1 may include the control electrode connected to a first node N1, an input electrode connected to a second node N2, and an output electrode connected to a first electrode of the light emitting element EE.

In the embodiment, the first transistor T1 may further include a second control electrode. In the embodiment, the second control electrode of the first transistor T1 may be connected to the output electrode of the first transistor T1. The first transistor T1 includes the second control electrode so that light leakage of the first transistor T1 may be prevented.

In addition, in the embodiment, each of the second to seventh transistors T2 to T7 may include a control electrode, an input electrode, an output electrode, and a second control electrode. The second control electrode of the second to seventh transistors T2 to T7 may be connected to the control electrode of the second to seventh transistors T2 to T7. Channels are generated at both a side of the control electrode of the second to seventh transistors T2 to T7 and a side of the second control electrode of the second to seventh transistors T2 to T7 so that driving abilities of the second to seventh transistors T2 to T7 may be enhanced.

According to the embodiment, the pixel includes two capacitors CTH and CST connected in series between the control electrode of a driving transistor T1 and the output electrode of the driving transistor T1 so that the compensating ability of the threshold voltage VTH of the driving transistor T1 may be enhanced.

The compensating ability of the threshold voltage VTH of the driving transistor T1 is enhanced so that the display quality of the display panel 100 may be enhanced.

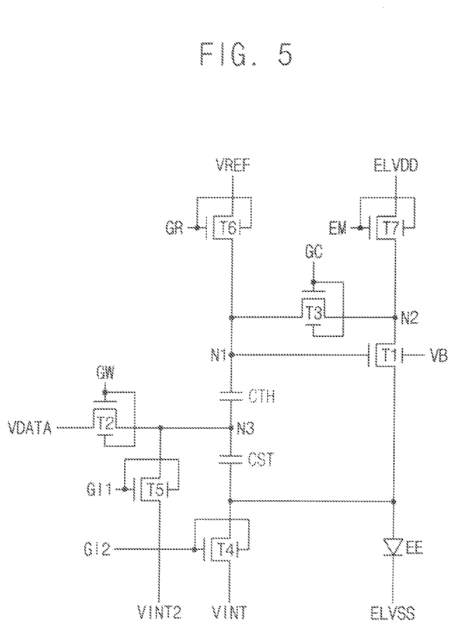

FIG. 5 is a schematic diagram of an equivalent circuit illustrating a pixel of a display panel of a display apparatus according to an embodiment of the disclosure.

The display apparatus according to the embodiment is substantially identical or similar to the display apparatus of the previous embodiment explained referring to FIGS. 1 to 3 except for the pixel structure. Thus, the same reference numerals will be used to refer to the same or like parts as those described in the previous embodiment of FIGS. 1 to 3, and any repetitive explanation concerning the above elements will be omitted.

Referring to FIGS. 1, 3, and 5, the display panel 100 includes the pixels. Each pixel includes a light emitting element EE.

The pixel receives a writing gate signal GW, a first initialization gate signal GI1, a second initialization gate signal GI2, a compensation gate signal GC, a reference gate signal GR, the data voltage VDATA, and the emission signal EM, and the light emitting element EE of the pixel emits light corresponding to the level of the data voltage VDATA to display the image.

The pixel may include the light emitting element EE, a first transistor T1, a second transistor T2, a first capacitor CTH, and a second capacitor CST. The first transistor T1 applies a driving current to the light emitting element EE. The second transistor T2 writes the data voltage VDATA. The first capacitor CTH includes a first end connected to a control electrode (N1) of the first transistor T1 and a second end connected to an output electrode (N3) of the second transistor T2. The second capacitor CST includes a first end connected to the output electrode (N3) of the second transistor T2 and a second end connected to an output electrode of the first transistor T1.

The first transistor T1 may include the control electrode connected to a first node N1, an input electrode connected to a second node N2, and an output electrode connected to a first electrode of the light emitting element EE.

In the embodiment, the first transistor T1 may further include a second control electrode. In the embodiment, a bias voltage VB may be applied to the second control electrode of the first transistor T1. The first transistor T1 includes the second control electrode so that light leakage of the first transistor T1 may be prevented. In addition, the bias voltage VB is properly set so that a negative shift of the threshold voltage of the first transistor T1 may be compensated.

In addition, in the embodiment, each of the second to seventh transistors T2 to T7 may include a control electrode, an input electrode, an output electrode, and a second control electrode. The second control electrode of the second to seventh transistors T2 to T7 may be connected to the control electrode of the second to seventh transistors T2 to T7. Channels are generated at a side or both sides of the control electrode of the second to seventh transistors T2 to T7 and a side of the second control electrode of the second to seventh transistors T2 to T7 so that driving abilities of the second to seventh transistors T2 to T7 may be enhanced.

According to the embodiment, the pixel includes two capacitors CTH and CST connected in series between the control electrode of a driving transistor T1 and the output electrode of the driving transistor T1 so that the compensating ability of the threshold voltage VTH of the driving transistor T1 may be enhanced.

The compensating ability of the threshold voltage VTH of the driving transistor T1 is enhanced so that the display quality of the display panel 100 may be enhanced.

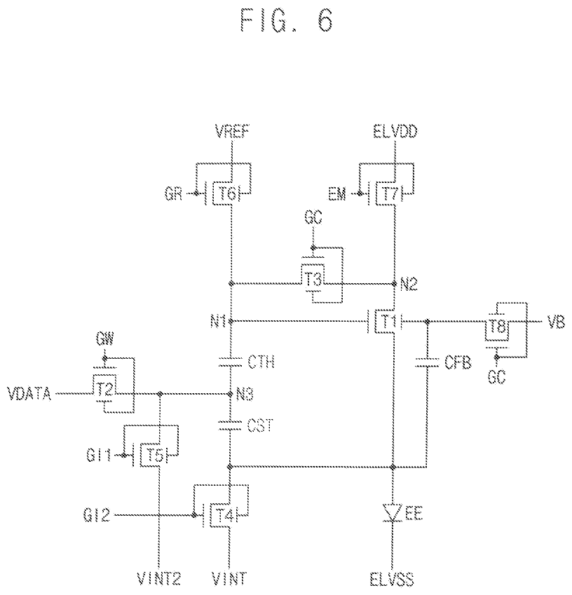

FIG. 6 is a schematic diagram of an equivalent circuit illustrating a pixel of a display panel of a display apparatus according to an embodiment of the disclosure.

The display apparatus according to the embodiment is substantially identical or similar to the display apparatus of the previous embodiment explained referring to FIGS. 1 to 3 except for the pixel structure. Thus, the same reference numerals will be used to refer to the same or like parts as those described in the previous embodiment of FIGS. 1 to 3, and any repetitive explanation concerning the above elements will be omitted.

Referring to FIGS. 1, 3, and 6, the display panel 100 includes the pixels. Each pixel includes a light emitting element EE.

The pixel receives a writing gate signal GW, a first initialization gate signal GI1, a second initialization gate signal GI2, a compensation gate signal GC, a reference gate signal GR, the data voltage VDATA, and the emission signal EM, and the light emitting element EE of the pixel emits light corresponding to the level of the data voltage VDATA to display the image.

The pixel may include the light emitting element EE, a first transistor T1, a second transistor T2, a first capacitor CTH, and a second capacitor CST. The first transistor T1 applies a driving current to the light emitting element EE. The second transistor T2 writes the data voltage VDATA. The first capacitor CTH includes a first end connected to a control electrode (N1) of the first transistor T1 and a second end connected to an output electrode (N3) of the second transistor T2. The second capacitor CST includes a first end connected to the output electrode (N3) of the second transistor T2 and a second end connected to an output electrode of the first transistor T1.

The first transistor T1 may include the control electrode connected to a first node N1, an input electrode connected to a second node N2, and an output electrode connected to a first electrode of the light emitting element EE.

In the embodiment, the first transistor T1 may further include a second control electrode. In the embodiment, the pixel may further include an eighth transistor T8 including a control electrode receiving a compensation gate signal GC, an input electrode receiving a bias voltage VB, and an output electrode connected to the second control electrode of the first transistor T1, and a third capacitor CFB including a first end connected to the second control electrode of the first transistor T1 and a second end connected to the output electrode of the first transistor T1.

In case that the compensation gate signal GC is activated, the bias voltage VB may be applied to the second control electrode of the first transistor T1 through the eighth transistor T8. The first transistor T1 includes the second control electrode so that light leakage of the first transistor T1 may be prevented. In addition, the bias voltage VB is properly set so that a negative shift of the threshold voltage of the first transistor T1 may be compensated. In addition, in case that the light emitting element EE emits the light, the voltage between the second control electrode of the first transistor T1 and the output electrode of the first transistor T1 may be constantly maintained by the third capacitor CFB.

In addition, in the embodiment, each of the second to seventh transistors T2 to T7 may include a control electrode, an input electrode, an output electrode, and a second control electrode. The second control electrode of the second to seventh transistors T2 to T7 may be connected to the control electrode of the second to seventh transistors T2 to T7. Channels are generated at a side or both sides of the control electrode of the second to seventh transistors T2 to T7 and a side of the second control electrode of the second to seventh transistors T2 to T7 so that driving abilities of the second to seventh transistors T2 to T7 may be enhanced.

According to the embodiment, the pixel includes two capacitors CTH and CST connected in series between the control electrode of a driving transistor T1 and the output electrode of the driving transistor T1 so that the compensating ability of the threshold voltage VTH of the driving transistor T1 may be enhanced.

The compensating ability of the threshold voltage VTH of the driving transistor T1 is enhanced so that the display quality of the display panel 100 may be enhanced.

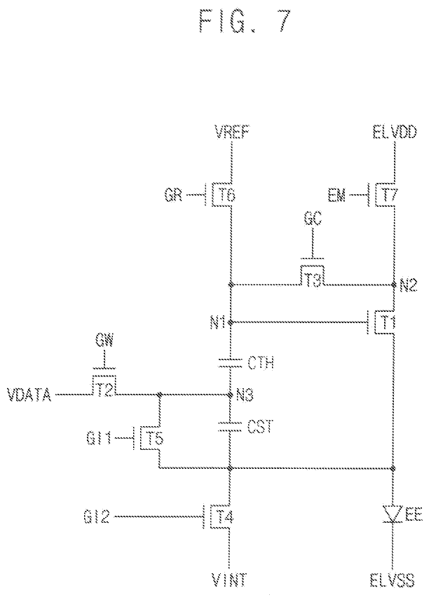

FIG. 7 is a schematic diagram of an equivalent circuit illustrating a pixel of a display panel of a display apparatus according to an embodiment of the disclosure.

The display apparatus according to the embodiment is substantially the same as the display apparatus of the previous embodiment explained referring to FIGS. 1 to 3 except for the pixel structure. Thus, the same reference numerals will be used to refer to the same or like parts as those described in the previous embodiment of FIGS. 1 to 3, and any repetitive explanation concerning the above elements will be omitted.

Referring to FIGS. 1, 3, and 7, the display panel 100 includes the pixels. Each pixel includes a light emitting element EE.

The pixel receives a writing gate signal GW, a first initialization gate signal GI1, a second initialization gate signal GI2, a compensation gate signal GC, a reference gate signal GR, the data voltage VDATA, and the emission signal EM, and the light emitting element EE of the pixel emits light corresponding to the level of the data voltage VDATA to display the image.

The pixel may include the light emitting element EE, a first transistor T1, a second transistor T2, a first capacitor CTH, and a second capacitor CST. The first transistor T1 applies a driving current to the light emitting element EE. The second transistor T2 writes the data voltage VDATA. The first capacitor CTH includes a first end connected to a control electrode (N1) of the first transistor T1 and a second end connected to an output electrode (N3) of the second transistor T2. The second capacitor CST includes a first end connected to the output electrode (N3) of the second transistor T2 and a second end connected to an output electrode of the first transistor T1.

In the embodiment, the pixel may further include a fourth transistor T4 including a control electrode receiving the second initialization gate signal GI2, an input electrode receiving an initialization voltage VINT, and an output electrode connected to a first electrode of the light emitting element EE.

In addition, in the embodiment, the pixel may further include a fifth transistor T5 including a control electrode receiving the first initialization gate signal GI1, an input electrode connected to the output electrode of the fourth transistor T4, and an output electrode connected to the output electrode (N3) of the second transistor T2.

In the embodiment, a second initialization voltage VINT2 is not applied to the pixel, and thus the pixel structure may be simplified than the pixel structure of FIG. 2.

According to the embodiment, the pixel includes two capacitors CTH and CST connected in series between the control electrode of a driving transistor T1 and the output electrode of the driving transistor T1 so that the compensating ability of the threshold voltage VTH of the driving transistor T1 may be enhanced.

The compensating ability of the threshold voltage VTH of the driving transistor T1 is enhanced so that the display quality of the display panel 100 may be enhanced.

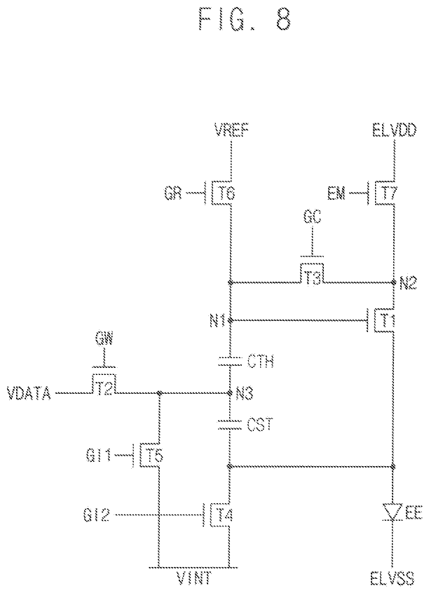

FIG. 8 is a schematic diagram of an equivalent circuit illustrating a pixel of a display panel of a display apparatus according to an embodiment of the disclosure.

The display apparatus according to the embodiment is substantially identical or similar to the display apparatus of the previous embodiment explained referring to FIGS. 1 to 3 except for the pixel structure. Thus, the same reference numerals will be used to refer to the same or like parts as those described in the previous embodiment of FIGS. 1 to 3, and any repetitive explanation concerning the above elements will be omitted.

Referring to FIGS. 1, 3, and 8, the display panel 100 includes the pixels. Each pixel includes a light emitting element EE.

The pixel receives a writing gate signal GW, a first initialization gate signal GI1, a second initialization gate signal GI2, a compensation gate signal GC, a reference gate signal GR, the data voltage VDATA, and the emission signal EM, and the light emitting element EE of the pixel emits light corresponding to the level of the data voltage VDATA to display the image.

The pixel may include the light emitting element EE, a first transistor T1, a second transistor T2, a first capacitor CTH, and a second capacitor CST. The first transistor T1 applies a driving current to the light emitting element EE. The second transistor T2 writes the data voltage VDATA. The first capacitor CTH includes a first end connected to a control electrode (N1) of the first transistor T1 and a second end connected to an output electrode (N3) of the second transistor T2. The second capacitor CST includes a first end connected to the output electrode (N3) of the second transistor T2 and a second end connected to an output electrode of the first transistor T1.

In the embodiment, the pixel may further include a fourth transistor T4 including a control electrode receiving the second initialization gate signal GI2, an input electrode receiving an initialization voltage VINT, and an output electrode connected to a first electrode of the light emitting element EE.

In addition, in the embodiment, the pixel may further include a fifth transistor T5 including a control electrode receiving the first initialization gate signal GI1, an input electrode receiving the initialization voltage VINT, and an output electrode connected to the output electrode (N3) of the second transistor T2.

In the embodiment, a second initialization voltage VINT2 is not applied to the pixel, and thus the pixel structure may be simplified than the pixel structure of FIG. 2.

According to the embodiment, the pixel includes two capacitors CTH and CST connected in series between the control electrode of a driving transistor T1 and the output electrode of the driving transistor T1 so that the compensating ability of the threshold voltage VTH of the driving transistor T1 may be enhanced.

The compensating ability of the threshold voltage VTH of the driving transistor T1 is enhanced so that the display quality of the display panel 100 may be enhanced.

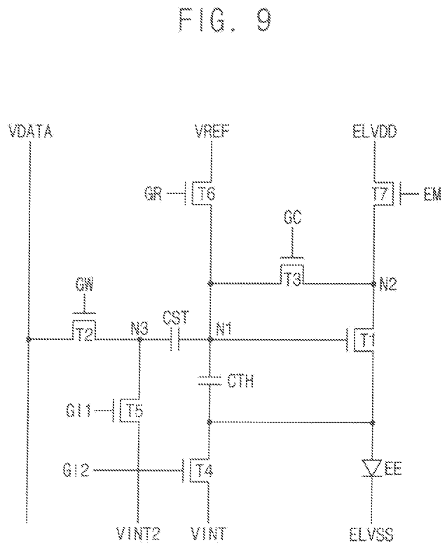

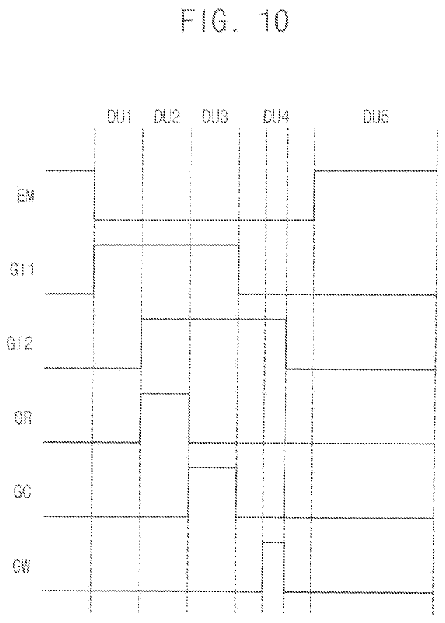

FIG. 9 is a schematic diagram of an equivalent circuit illustrating a pixel of a display panel of a display apparatus according to an embodiment of the disclosure. FIG. 10 is a schematic timing diagram illustrating input signals applied to the pixel of FIG. 9.

The display apparatus according to the embodiment is substantially identical or similar to the display apparatus of the previous embodiment explained referring to FIGS. 1 to 3 except for the pixel structure and the input signals applied to the pixels. Thus, the same reference numerals will be used to refer to the same or like parts as those described in the previous embodiment of FIGS. 1 to 3, and any repetitive explanation concerning the above elements will be omitted.

Referring to FIGS. 1, 9, and 10, the display panel 100 includes the pixels. Each pixel includes a light emitting element EE.

The pixel receives a writing gate signal GW, a first initialization gate signal GIL a second initialization gate signal GI2, a compensation gate signal GC, a reference gate signal GR, the data voltage VDATA, and the emission signal EM, and the light emitting element EE of the pixel emits light corresponding to the level of the data voltage VDATA to display the image.

The pixel may include the light emitting element EE, a first transistor T1, a second transistor T2, a first capacitor CTH, and a second capacitor CST. The first transistor T1 applies a driving current to the light emitting element EE. The second transistor T2 writes the data voltage VDATA. The first capacitor CTH includes a first end connected to a control electrode (N1) of the first transistor T1 and a second end connected to an output electrode of the first transistor T1. The second capacitor CST includes a first end connected to the output electrode (N3) of the second transistor T2 and a second end connected to the control electrode (N1) of the first transistor T1.

The first transistor T1 may include the control electrode connected to a first node N1, an input electrode connected to a second node N2, and an output electrode connected to a first electrode of the light emitting element EE.

The second transistor T2 may include a control electrode receiving the writing gate signal GW, an input electrode receiving the data voltage VDATA, and the output electrode connected to the third node N3.

The light emitting element EE may include the first electrode connected to the output electrode of the first transistor T1 and a second electrode receiving a second power voltage ELVSS. For example, the first electrode of the light emitting element EE is an anode electrode, and the second electrode of the light emitting element EE is a cathode electrode.

The pixel may further include a third transistor T3 including a control electrode receiving the compensation gate signal GC, an input electrode connected to the input electrode of the first transistor T1, and an output electrode connected to the control electrode (N1) of the first transistor T1.

The pixel may further include a fourth transistor T4 including a control electrode receiving the second initialization gate signal GI2, an input electrode receiving an initialization voltage VINT, and an output electrode connected to the first electrode of the light emitting element EE.

The pixel may further include a fifth transistor T5 including a control electrode receiving the first initialization gate signal GIL an input electrode receiving a second initialization voltage VINT2, and an output electrode connected to the output electrode (N3) of the second transistor T2.

The pixel may further include a sixth transistor T6 including a control electrode receiving the reference gate signal GR, an input electrode receiving a reference voltage VREF, and an output electrode connected to the control electrode (N1) of the first transistor T1.

The pixel may further include a seventh transistor T7 including a control electrode receiving the emission signal EM, an input electrode receiving a first power voltage ELVDD, and an output electrode connected to the input electrode (N2) of the first transistor T1.

For example, the first power voltage ELVDD may be greater than the second power voltage ELVSS. For example, the first power voltage ELVDD may be a high power voltage of the pixel and the second power voltage ELVSS may be a low power voltage of the pixel.

For example, the first to seventh transistors T1 to T7 may be N-type transistors. For example, the first to seventh transistors T1 to T7 may be oxide transistors.

In a first duration DU1 of FIG. 10, the emission signal EM may have an inactive level, the first initialization gate signal GI1 may have an active level, the second initialization gate signal GI2 may have an inactive level, the reference gate signal GR may have an inactive level, the compensation gate signal GC may have an inactive level, and the writing gate signal GW may have an inactive level.

The first duration DU1 of FIG. 10 may be a first initialization duration. In the first duration DU1 of FIG. 10, the first and fifth transistors T1 and T5 may be turned on. In this case, the second initialization voltage VINT2 may be applied to the third node N3 through the fifth transistor T5.

In a second duration DU2 of FIG. 10, the emission signal EM may have the inactive level, the first initialization gate signal GI1 may have the active level, the second initialization gate signal GI2 may have an active level, the reference gate signal GR may have an active level, the compensation gate signal GC may have the inactive level, and the writing gate signal GW may have the inactive level.

The second duration DU2 of FIG. 10 may be a second initialization duration. In the second duration DU2 of FIG. 10, the first, fourth, fifth, and sixth transistors T1, T4, T5, and T6 may be turned on. In this case, the second initialization voltage VINT2 may be applied to the third node N3 through the fifth transistor T5.

In the second initialization duration DU2, the reference voltage VREF, the second initialization voltage VINT2, and the initialization voltage VINT may be respectively applied to the first node N1, the third node N3, and the anode electrode of the light emitting element EE so that the control electrode of the first transistor T1, the first capacitor CTH, the second capacitor CST, and the anode electrode of the light emitting element EE may be respectively initialized.

In a third duration DU3 of FIG. 10, the emission signal EM may have the inactive level, the first initialization gate signal GI1 may have the active level, the second initialization gate signal GI2 may have the active level, the reference gate signal GR may have the inactive level, the compensation gate signal GC may have an active level, and the writing gate signal GW may have the inactive level.

The third duration DU3 of FIG. 10 may be a threshold voltage compensation duration. In the third duration DU3 of FIG. 10, the first, third, fourth, and fifth transistors T1, T3, T4, and T5 may be turned on. A component of the threshold voltage of the first transistor T1 may be stored in the first capacitor CTH through a path of the third transistor T3 and the first transistor T1.

In a fourth duration DU4 of FIG. 10, the emission signal EM may have the inactive level, the first initialization gate signal GI1 may have an inactive level, the second initialization gate signal GI2 may have the active level, the reference gate signal GR may have the inactive level, the compensation gate signal GC may have the inactive level, and the writing gate signal GW may have an active level.

The fourth duration DU4 of FIG. 10 may be a data writing duration. In the fourth duration DU4 of FIG. 10, the first, second, and fourth transistors T1, T2, and T4 may be turned on. The data voltage VDATA may be written at the third node N3 through the second transistor T2.

In a fifth duration DU5 of FIG. 10, the emission signal EM may have an active level, the first initialization gate signal GI1 may have the inactive level, the second initialization gate signal GI2 may have the inactive level, the reference gate signal GR may have the inactive level, the compensation gate signal GC may have the inactive level, and the writing gate signal GW may have the inactive level.

The fifth duration DU5 of FIG. 10 may be a light emitting duration. In the fifth duration DU5 of FIG. 10, the first and seventh transistors T1 and T7 may be turned on. The light emitting element EE may emit light by a current flowing through the seventh transistor T7, the first transistor T1, and the light emitting element EE. A luminance of the light emitting element EE may be determined by a voltage of the control electrode of the first transistor T1.

According to the embodiment, the pixel includes the first capacitor CTH disposed between the control electrode of the driving transistor T1 and the output electrode of the driving transistor T1 and the second capacitor CST disposed between the control electrode of the driving transistor T1 and the output electrode of the writing transistor (T2) so that the compensating ability of the threshold voltage VTH of the driving transistor T1 may be enhanced.

The compensating ability of the threshold voltage VTH of the driving transistor T1 is enhanced so that the display quality of the display panel 100 may be enhanced.

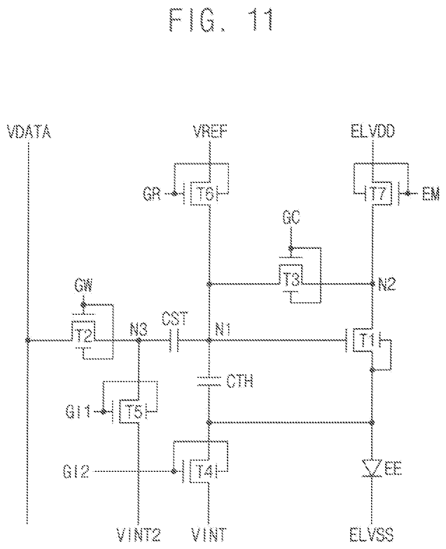

FIG. 11 is a schematic diagram of an equivalent circuit illustrating a pixel of a display panel of a display apparatus according to an embodiment of the disclosure.

The display apparatus according to the embodiment is substantially identical or similar to the display apparatus of the previous embodiment explained referring to FIGS. 9 and 10 except for the pixel structure. Thus, the same reference numerals will be used to refer to the same or like parts as those described in the previous embodiment of FIGS. 9 and 10, and any repetitive explanation concerning the above elements will be omitted.

Referring to FIGS. 1, 10, and 11, the display panel 100 includes the pixels. Each pixel includes a light emitting element EE.

The pixel receives a writing gate signal GW, a first initialization gate signal GI1, a second initialization gate signal GI2, a compensation gate signal GC, a reference gate signal GR, the data voltage VDATA, and the emission signal EM, and the light emitting element EE of the pixel emits light corresponding to the level of the data voltage VDATA to display the image.

The pixel may include the light emitting element EE, a first transistor T1, a second transistor T2, a first capacitor CTH, and a second capacitor CST. The first transistor T1 applies a driving current to the light emitting element EE. The second transistor T2 writes the data voltage VDATA. The first capacitor CTH includes a first end connected to a control electrode (N1) of the first transistor T1 and a second end connected to an output electrode of the first transistor T1. The second capacitor CST includes a first end connected to the output electrode (N3) of the second transistor T2 and a second end connected to the control electrode (N1) of the first transistor T1.

The first transistor T1 may include the control electrode connected to a first node N1, an input electrode connected to a second node N2, and an output electrode connected to a first electrode of the light emitting element EE.

In the embodiment, the first transistor T1 may further include a second control electrode. In the embodiment, the second control electrode of the first transistor T1 may be connected to the output electrode of the first transistor T1. The first transistor T1 includes the second control electrode so that light leakage of the first transistor T1 may be prevented.

In addition, in the embodiment, each of the second to seventh transistors T2 to T7 may include a control electrode, an input electrode, an output electrode, and a second control electrode. The second control electrode of the second to seventh transistors T2 to T7 may be connected to the control electrode of the second to seventh transistors T2 to T7. Channels are generated at a side or both sides of the control electrode of the second to seventh transistors T2 to T7 and a side of the second control electrode of the second to seventh transistors T2 to T7 so that driving abilities of the second to seventh transistors T2 to T7 may be enhanced.

According to the embodiment, the pixel includes the first capacitor CTH disposed between the control electrode of the driving transistor T1 and the output electrode of the driving transistor T1 and the second capacitor CST disposed between the control electrode of the driving transistor T1 and the output electrode of the writing transistor T2 so that the compensating ability of the threshold voltage VTH of the driving transistor T1 may be enhanced.

The compensating ability of the threshold voltage VTH of the driving transistor T1 is enhanced so that the display quality of the display panel 100 may be enhanced.

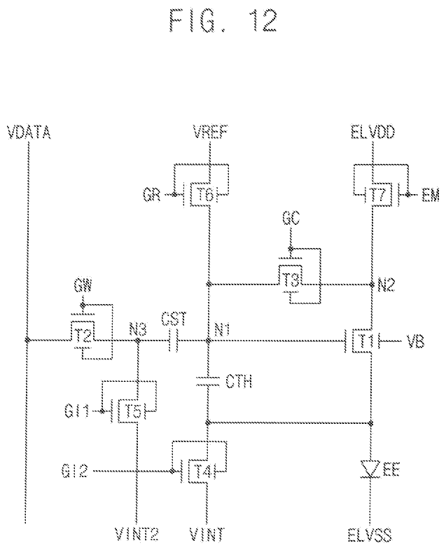

FIG. 12 is a schematic diagram of an equivalent circuit illustrating a pixel of a display panel of a display apparatus according to an embodiment of the disclosure.

The display apparatus according to the embodiment is substantially the same as the display apparatus of the previous embodiment explained referring to FIGS. 9 and 10 except for the pixel structure. Thus, the same reference numerals will be used to refer to the same or like parts as those described in the previous embodiment of FIGS. 9 and 10, and any repetitive explanation concerning the above elements will be omitted.

Referring to FIGS. 1, 10, and 12, the display panel 100 includes the pixels. Each pixel includes a light emitting element EE.

The pixel receives a writing gate signal GW, a first initialization gate signal GI1, a second initialization gate signal GI2, a compensation gate signal GC, a reference gate signal GR, the data voltage VDATA, and the emission signal EM, and the light emitting element EE of the pixel emits light corresponding to the level of the data voltage VDATA to display the image.

The pixel may include the light emitting element EE, a first transistor T1, a second transistor T2, a first capacitor CTH, and a second capacitor CST. The first transistor T1 applies a driving current to the light emitting element EE. The second transistor T2 writes the data voltage VDATA. The first capacitor CTH includes a first end connected to a control electrode (N1) of the first transistor T1 and a second end connected to an output electrode of the first transistor T1. The second capacitor CST includes a first end connected to the output electrode (N3) of the second transistor T2 and a second end connected to the control electrode (N1) of the first transistor T1.

The first transistor T1 may include the control electrode connected to a first node N1, an input electrode connected to a second node N2, and an output electrode connected to a first electrode of the light emitting element EE.

In the embodiment, the first transistor T1 may further include a second control electrode. In the embodiment, a bias voltage VB may be applied to the second control electrode of the first transistor T1. The first transistor T1 includes the second control electrode so that light leakage of the first transistor T1 may be prevented. In addition, the bias voltage VB is properly set so that a negative shift of the threshold voltage of the first transistor T1 may be compensated.

In addition, in the embodiment, each of the second to seventh transistors T2 to T7 may include a control electrode, an input electrode, an output electrode, and a second control electrode. The second control electrode of the second to seventh transistors T2 to T7 may be connected to the control electrode of the second to seventh transistors T2 to T7. Channels are generated at a side or both sizes of the control electrode of the second to seventh transistors T2 to T7 and a side of the second control electrode of the second to seventh transistors T2 to T7 so that driving abilities of the second to seventh transistors T2 to T7 may be enhanced.

According to the embodiment, the pixel includes the first capacitor CTH disposed between the control electrode of the driving transistor T1 and the output electrode of the driving transistor T1 and the second capacitor CST disposed between the control electrode of the driving transistor T1 and the output electrode of the writing transistor T2 so that the compensating ability of the threshold voltage VTH of the driving transistor T1 may be enhanced.

The compensating ability of the threshold voltage VTH of the driving transistor T1 is enhanced so that the display quality of the display panel 100 may be enhanced.

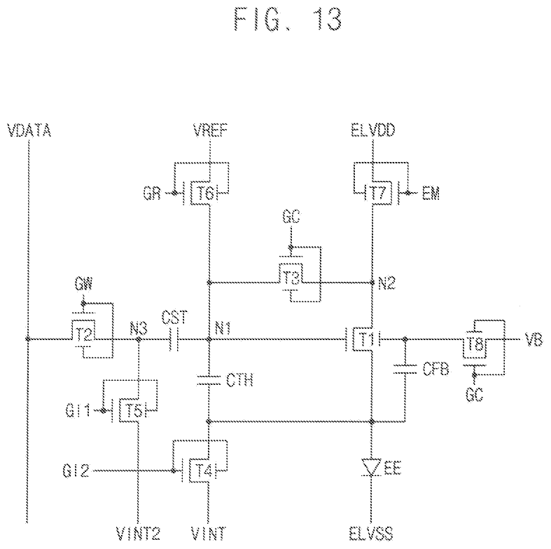

FIG. 13 is a schematic diagram of an equivalent circuit illustrating a pixel of a display panel of a display apparatus according to an embodiment of the disclosure.

The display apparatus according to the embodiment is substantially the same as the display apparatus of the previous embodiment explained referring to FIGS. 9 and 10 except for the pixel structure. Thus, the same reference numerals will be used to refer to the same or like parts as those described in the previous embodiment of FIGS. 9 and 10, and any repetitive explanation concerning the above elements will be omitted.

Referring to FIGS. 1, 10, and 13, the display panel 100 includes the pixels. Each pixel includes a light emitting element EE.

The pixel receives a writing gate signal GW, a first initialization gate signal GI1, a second initialization gate signal GI2, a compensation gate signal GC, a reference gate signal GR, the data voltage VDATA, and the emission signal EM, and the light emitting element EE of the pixel emits light corresponding to the level of the data voltage VDATA to display the image.

The pixel may include the light emitting element EE, a first transistor T1, a second transistor T2, a first capacitor CTH, and a second capacitor CST. The first transistor T1 applies a driving current to the light emitting element EE. The second transistor T2 writes the data voltage VDATA. The first capacitor CTH includes a first end connected to a control electrode (N1) of the first transistor T1 and a second end connected to an output electrode of the first transistor T1. The second capacitor CST includes a first end connected to the output electrode (N3) of the second transistor T2 and a second end connected to the control electrode (N1) of the first transistor T1.

The first transistor T1 may include the control electrode connected to a first node N1, an input electrode connected to a second node N2, and an output electrode connected to a first electrode of the light emitting element EE.

In the embodiment, the first transistor T1 may further include a second control electrode. In the embodiment, the pixel may further include an eighth transistor T8 including a control electrode receiving a compensation gate signal GC, an input electrode receiving a bias voltage VB, and an output electrode connected to the second control electrode of the first transistor T1, and a third capacitor CFB including a first end connected to the second control electrode of the first transistor T1 and a second end connected to the output electrode of the first transistor T1.

In case that the compensation gate signal GC is activated, the bias voltage VB may be applied to the second control electrode of the first transistor T1 through the eighth transistor T8. The first transistor T1 includes the second control electrode so that light leakage of the first transistor T1 may be prevented. In addition, the bias voltage VB is properly set so that a negative shift of the threshold voltage of the first transistor T1 may be compensated for. In addition, in case that the light emitting element EE emits the light, the voltage between the second control electrode of the first transistor T1 and the output electrode of the first transistor T1 may be constantly maintained by the third capacitor CFB.

In addition, in the embodiment, each of the second to seventh transistors T2 to T7 may include a control electrode, an input electrode, an output electrode, and a second control electrode. The second control electrode of the second to seventh transistors T2 to T7 may be connected to the control electrode of the second to seventh transistors T2 to T7. Channels are generated at a side of the control electrode of the second to seventh transistors T2 to T7 and a side of the second control electrode of the second to seventh transistors T2 to T7 so that driving abilities of the second to seventh transistors T2 to T7 may be enhanced.

According to the embodiment, the pixel includes the first capacitor CTH disposed between the control electrode of the driving transistor T1 and the output electrode of the driving transistor T1 and the second capacitor CST disposed between the control electrode of the driving transistor T1 and the output electrode of the writing transistor T2 so that the compensating ability of the threshold voltage VTH of the driving transistor T1 may be enhanced.

The compensating ability of the threshold voltage VTH of the driving transistor T1 is enhanced so that the display quality of the display panel 100 may be enhanced.

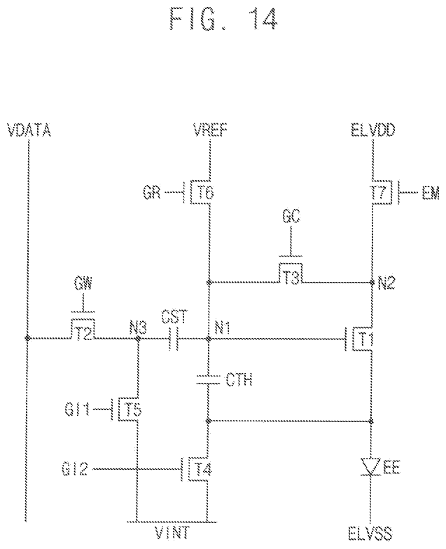

FIG. 14 is a schematic timing diagram illustrating input signals applied to a pixel of a display panel of a display apparatus according to an embodiment of the disclosure.

The display apparatus according to the embodiment is substantially the same as the display apparatus of the previous embodiment explained referring to FIGS. 9 and 10 except for the pixel structure. Thus, the same reference numerals will be used to refer to the same or like parts as those described in the previous embodiment of FIGS. 9 and 10, and any repetitive explanation concerning the above elements will be omitted.

Referring to FIGS. 1, 10, and 14, the display panel 100 includes the pixels. Each pixel includes a light emitting element EE.

The pixel receives a writing gate signal GW, a first initialization gate signal GI1, a second initialization gate signal GI2, a compensation gate signal GC, a reference gate signal GR, the data voltage VDATA, and the emission signal EM, and the light emitting element EE of the pixel emits light corresponding to the level of the data voltage VDATA to display the image.

The pixel may include the light emitting element EE, a first transistor T1, a second transistor T2, a first capacitor CTH, and a second capacitor CST. The first transistor T1 applies a driving current to the light emitting element EE. The second transistor T2 writes the data voltage VDATA. The first capacitor CTH includes a first end connected to a control electrode (N1) of the first transistor T1 and a second end connected to an output electrode of the first transistor T1. The second capacitor CST includes a first end connected to the output electrode (N3) of the second transistor T2 and a second end connected to the control electrode (N1) of the first transistor T1.

In the embodiment, the pixel may further include a fourth transistor T4 including a control electrode receiving the second initialization gate signal GI2, an input electrode receiving an initialization voltage VINT, and an output electrode connected to a first electrode of the light emitting element EE.

In addition, in the embodiment, the pixel may further include a fifth transistor T5 including a control electrode receiving the first initialization gate signal GI1, an input electrode receiving the initialization voltage VINT, and an output electrode connected to the output electrode (N3) of the second transistor T2.

In the embodiment, a second initialization voltage VINT2 is not applied to the pixel, and thus the pixel structure may be simplified than the pixel structure of FIG. 9.

According to the embodiment, the pixel includes the first capacitor CTH disposed between the control electrode of the driving transistor T1 and the output electrode of the driving transistor T1 and the second capacitor CST disposed between the control electrode of the driving transistor T1 and the output electrode of the writing transistor T2 so that the compensating ability of the threshold voltage VTH of the driving transistor T1 may be enhanced.

The compensating ability of the threshold voltage VTH of the driving transistor T1 is enhanced so that the display quality of the display panel 100 may be enhanced.

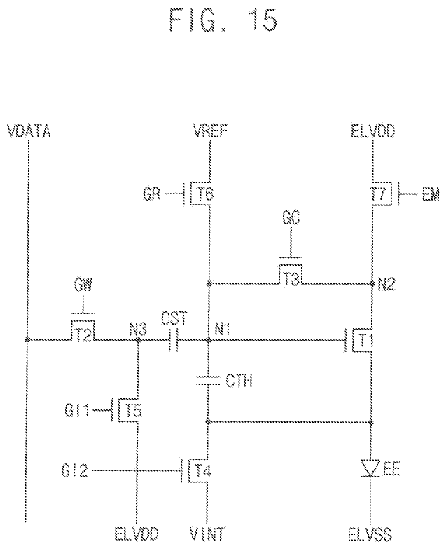

FIG. 15 is a schematic diagram of an equivalent circuit illustrating a pixel of a display panel of a display apparatus according to an embodiment of the disclosure.

The display apparatus according to the embodiment is substantially the same as the display apparatus of the previous embodiment explained referring to FIGS. 9 and 10 except for the pixel structure. Thus, the same reference numerals will be used to refer to the same or like parts as those described in the previous embodiment of FIGS. 9 and 10, and any repetitive explanation concerning the above elements will be omitted.

Referring to FIGS. 1, 10, and 15, the display panel 100 includes the pixels. Each pixel includes a light emitting element EE.

The pixel receives a writing gate signal GW, a first initialization gate signal GIL a second initialization gate signal GI2, a compensation gate signal GC, a reference gate signal GR, the data voltage VDATA, and the emission signal EM, and the light emitting element EE of the pixel emits light corresponding to the level of the data voltage VDATA to display the image.

The pixel may include the light emitting element EE, a first transistor T1, a second transistor T2, a first capacitor CTH, and a second capacitor CST. The first transistor T1 applies a driving current to the light emitting element EE. The second transistor T2 writes the data voltage VDATA. The first capacitor CTH includes a first end connected to a control electrode (N1) of the first transistor T1 and a second end connected to an output electrode of the first transistor T1. The second capacitor CST includes a first end connected to the output electrode (N3) of the second transistor T2 and a second end connected to the control electrode (N1) of the first transistor T1.

In the embodiment, the pixel may further include a fourth transistor T4 including a control electrode receiving the second initialization gate signal GI2, an input electrode receiving an initialization voltage VINT, and an output electrode connected to a first electrode of the light emitting element EE.

In addition, in the embodiment, the pixel may further include a fifth transistor T5 including a control electrode receiving the first initialization gate signal GIL an input electrode receiving the first power voltage ELVDD, and an output electrode connected to the output electrode (N3) of the second transistor T2.

In the embodiment, a second initialization voltage VINT2 is not applied to the pixel, and thus the pixel structure may be simplified than the pixel structure of FIG. 9.

According to the embodiment, the pixel includes the first capacitor CTH disposed between the control electrode of the driving transistor T1 and the output electrode of the driving transistor T1 and the second capacitor CST disposed between the control electrode of the driving transistor T1 and the output electrode of the writing transistor T2 so that the compensating ability of the threshold voltage VTH of the driving transistor T1 may be enhanced.

The compensating ability of the threshold voltage VTH of the driving transistor T1 is enhanced so that the display quality of the display panel 100 may be enhanced.

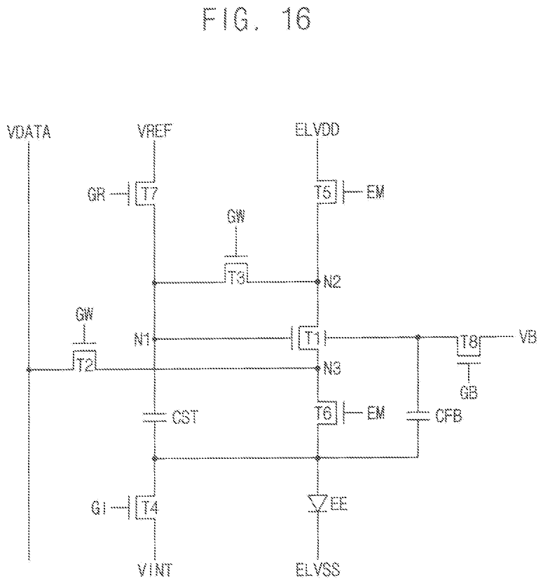

FIG. 16 is a schematic diagram of an equivalent circuit illustrating a pixel of a display panel of a display apparatus according to an embodiment of the disclosure.

The display apparatus according to the embodiment is substantially the same as the display apparatus of the previous embodiment explained referring to FIGS. 1 to 3 except for the pixel structure. Thus, the same reference numerals will be used to refer to the same or like parts as those described in the previous embodiment of FIGS. 1 to 3, and any repetitive explanation concerning the above elements will be omitted.

Referring to FIGS. 1 and 16, the display panel 100 includes the pixels. Each pixel includes a light emitting element EE.

The pixel may include a first transistor T1, a second transistor T2, a third transistor T3, a fourth transistor T4, a fifth transistor T5, a sixth transistor T6, a seventh transistor T7, an eighth transistor T8, and a light emitting element EE. The first transistor T1 may include a control electrode connected to a first node N1, an input electrode connected to a second node N2, an output electrode connected to a third node N3, and a second control electrode connected to an output electrode of the eighth transistor T8. The second transistor T2 may include a control electrode receiving a writing gate signal GW, an input electrode receiving a data voltage VDATA, and an output electrode connected to the third node N3. The third transistor T3 may include a control electrode receiving the writing gate signal GW, an input electrode connected to the second node N2, and an output electrode connected to the first node N1. The fourth transistor T4 may include a control electrode receiving an initialization gate signal GI, an input electrode receiving an initialization voltage VINT, and an output electrode connected to a first electrode of the light emitting element EE. The fifth transistor T5 may include a control electrode receiving an emission signal EM, an input electrode receiving a first power voltage ELVDD, and an output electrode connected to the second node N2. The sixth transistor T6 may include a control electrode receiving the emission signal EM, an input electrode connected to the third node N3, and an output electrode connected to the first electrode of the light emitting element EE. The seventh transistor T7 may include a control electrode receiving a reference gate signal GR, an input electrode receiving a reference voltage VREF, and an output electrode connected to the first node N1. The eighth transistor T8 may include a control electrode receiving a bias gate signal GB, an input electrode receiving a bias voltage VB, and an output electrode connected to the second control electrode of the first transistor T1. The light emitting element EE may include the first electrode connected to the output electrode of the sixth transistor T6 and a second electrode receiving a second power voltage ELVSS.

In the embodiment, the pixel of the display apparatus may include a first capacitor CST including a first end connected to the first node N1 and a second end connected to the first electrode of the light emitting element EE and a second capacitor CFB including a first end connected to the output electrode of the eighth transistor T8 and a second end connected to the first electrode of the light emitting element EE.

For example, the first to eighth transistors T1 to T8 may be N-type transistors. For example, the first to eighth transistors T1 to T8 may be oxide transistors.

According to the pixel of the display apparatus of the disclosure as explained above, the compensating ability of the threshold voltage may be enhanced and the display quality of the display panel may be enhanced.

The above description is an example of technical features of the disclosure, and those skilled in the art to which the disclosure pertains will be able to make various modifications and variations. Therefore, the embodiments of the disclosure described above may be implemented separately or in combination with each other.

Therefore, the embodiments disclosed in the disclosure are not intended to limit the technical spirit of the disclosure, but to describe the technical spirit of the disclosure, and the scope of the technical spirit of the disclosure is not limited by these embodiments. The protection scope of the disclosure should be interpreted by the following claims, and it should be interpreted that all technical spirits within the equivalent scope are included in the scope of the disclosure.

What is claimed is:

1. A pixel of a display apparatus comprising:
a light emitting element;
a first transistor that applies a driving current to the light emitting element;
a second transistor that transmits a data voltage;
a first capacitor including:
a first end electrically connected to a control electrode of the first transistor; and
a second end electrically connected to an output electrode of the second transistor; and
a second capacitor including:
a first end electrically connected to the output electrode of the second transistor; and
a second end electrically connected to an output electrode of the first transistor.

2. The pixel of the display apparatus of claim 1, further comprising:
a third transistor including:
a control electrode that receives a compensation gate signal;
an input electrode electrically connected to an input electrode of the first transistor; and
an output electrode electrically connected to the control electrode of the first transistor.

3. The pixel of the display apparatus of claim 2, further comprising:
a fourth transistor including:
a control electrode that receives a second initialization gate signal;
an input electrode that receives an initialization voltage; and
an output electrode electrically connected to a first electrode of the light emitting element; and
a fifth transistor including:
a control electrode that receives a first initialization gate signal;
an input electrode that receives a second initialization voltage; and
an output electrode electrically connected to the output electrode of the second transistor.

4. The pixel of the display apparatus of claim 3, further comprising:
a sixth transistor including:
a control electrode that receives a reference gate signal;
an input electrode that receives a reference voltage; and
an output electrode electrically connected to the control electrode of the first transistor; and
a seventh transistor including:
a control electrode that receives an emission signal;
an input electrode that receives a first power voltage; and
an output electrode electrically connected to the input electrode of the first transistor.

5. The pixel of the display apparatus of claim 4, wherein the first to seventh transistors are N-type transistors.

6. The pixel of the display apparatus of claim 1, wherein
the first transistor includes the control electrode, an input electrode, the output electrode, and a second control electrode, and
the second control electrode of the first transistor is electrically connected to the output electrode of the first transistor.

7. The pixel of the display apparatus of claim 1, wherein
the first transistor includes the control electrode, an input electrode, the output electrode, and a second control electrode, and
a bias voltage is applied to the second control electrode of the first transistor.

8. The pixel of the display apparatus of claim 1, wherein
the first transistor includes the control electrode, an input electrode, the output electrode, and a second control electrode, and
the pixel further comprises:
an eighth transistor including:
a control electrode that receives a compensation gate signal;
an input electrode that receives a bias voltage; and
an output electrode electrically connected to the second control electrode of the first transistor; and
a third capacitor including:
a first end electrically connected to the second control electrode of the first transistor; and
a second end electrically connected to the output electrode of the first transistor.

9. The pixel of the display apparatus of claim 1, further comprising:
a fourth transistor including:
a control electrode that receives a second initialization gate signal;
an input electrode that receives an initialization voltage; and
an output electrode electrically connected to a first electrode of the light emitting element; and
a fifth transistor including:
a control electrode that receives a first initialization gate signal;
an input electrode electrically connected to the output electrode of the fourth transistor; and
an output electrode electrically connected to the output electrode of the second transistor.

10. The pixel of the display apparatus of claim 1, further comprising:
a fourth transistor including:
a control electrode that receives a second initialization gate signal;
an input electrode that receives an initialization voltage; and
an output electrode electrically connected to a first electrode of the light emitting element; and
a fifth transistor including:
a control electrode that receives a first initialization gate signal;
an input electrode that receives the initialization voltage; and
an output electrode electrically connected to the output electrode of the second transistor.

11. A pixel of a display apparatus comprising:
a light emitting element;
a first transistor that applies a driving current to the light emitting element;
a second transistor that transmits a data voltage;
a first capacitor including:
a first end electrically connected to a control electrode of the first transistor; and
a second end electrically connected to an output electrode of the first transistor; and
a second capacitor including:
a first end electrically connected to an output electrode of the second transistor; and
a second end electrically connected to the control electrode of the first transistor.

12. The pixel of the display apparatus of claim 11, further comprising:
a third transistor including:
a control electrode that receives a compensation gate signal;
an input electrode electrically connected to an input electrode of the first transistor; and
an output electrode electrically connected to the control electrode of the first transistor.

13. The pixel of the display apparatus of claim 12, further comprising:
a fourth transistor including:
a control electrode that receives a second initialization gate signal;
an input electrode that receives an initialization voltage; and
an output electrode electrically connected to a first electrode of the light emitting element; and
a fifth transistor including:
a control electrode that receives a first initialization gate signal;
an input electrode that receives a second initialization voltage; and
an output electrode electrically connected to the output electrode of the second transistor.

14. The pixel of the display apparatus of claim 13, further comprising:
a sixth transistor including:
a control electrode that receives a reference gate signal;
an input electrode that receives a reference voltage; and
an output electrode electrically connected to the control electrode of the first transistor; and
a seventh transistor including:
a control electrode that receives an emission signal;
an input electrode that receives a first power voltage; and
an output electrode electrically connected to the input electrode of the first transistor.

15. The pixel of the display apparatus of claim 14, wherein the first to seventh transistors are N-type transistors.

16. The pixel of the display apparatus of claim 11, wherein
the first transistor includes the control electrode, an input electrode, the output electrode and a second control electrode, and
the second control electrode of the first transistor is electrically connected to the output electrode of the first transistor.

17. The pixel of the display apparatus of claim 11, wherein
the first transistor includes the control electrode, an input electrode, the output electrode and a second control electrode, and
a bias voltage is applied to the second control electrode of the first transistor.

18. The pixel of the display apparatus of claim 11, wherein
the first transistor includes the control electrode, an input electrode, the output electrode and a second control electrode, and
the pixel further comprises:
an eighth transistor including:
a control electrode that receives a compensation gate signal;
an input electrode that receives a bias voltage; and
an output electrode electrically connected to the second control electrode of the first transistor; and
a third capacitor including:
a first end electrically connected to the second control electrode of the first transistor; and
a second end electrically connected to the output electrode of the first transistor.

19. The pixel of the display apparatus of claim 11, further comprising:
a fourth transistor including:
a control electrode that receives a second initialization gate signal;
an input electrode that receives an initialization voltage; and
an output electrode electrically connected to a first electrode of the light emitting element; and
a fifth transistor including:
a control electrode that receives a first initialization gate signal;
an input electrode that receives the initialization voltage; and
an output electrode electrically connected to the output electrode of the second transistor.

20. The pixel of the display apparatus of claim 11, further comprising:
a fourth transistor including:
a control electrode that receives a second initialization gate signal;
an input electrode that receives an initialization voltage; and
an output electrode electrically connected to a first electrode of the light emitting element; and
a fifth transistor including:
a control electrode that receives a first initialization gate signal;
an input electrode that receives a first power voltage; and
an output electrode electrically connected to the output electrode of the second transistor.

21. A pixel of a display apparatus comprising:
a first transistor including:
a control electrode electrically connected to a first node;
an input electrode electrically connected to a second node;
an output electrode electrically connected to a third node; and
a second control electrode electrically connected to an output electrode of an eighth transistor;
a second transistor including:
a control electrode that receives a writing gate signal;
an input electrode that receives a data voltage; and
an output electrode electrically connected to the third node;
a third transistor including:
a control electrode that receives the writing gate signal;
an input electrode electrically connected to the second node; and
an output electrode electrically connected to the first node;
a fourth transistor including:
a control electrode that receives an initialization gate signal;
an input electrode that receives an initialization voltage; and
an output electrode electrically connected to a first electrode of a light emitting element;
a fifth transistor including:
a control electrode that receives an emission signal;
an input electrode that receives a first power voltage; and
an output electrode electrically connected to the second node;
a sixth transistor including:
a control electrode that receives the emission signal;
an input electrode electrically connected to the third node; and
an output electrode electrically connected to the first electrode of the light emitting element;
a seventh transistor including:
a control electrode that receives a reference gate signal;
an input electrode that receives reference voltage; and
an output electrode electrically connected to the first node;
the eighth transistor including:
a control electrode that receives a bias gate signal;
an input electrode that receives a bias voltage; and
the output electrode electrically connected to the second control electrode of the first transistor; and
the light emitting element including:
the first electrode electrically connected to the output electrode of the sixth transistor; and
a second electrode that receives a second power voltage.

22. The pixel of the display apparatus of claim 21, further comprising:
a first capacitor including:
a first end electrically connected to the first node; and
a second end electrically connected to the first electrode of the light emitting element; and
a second capacitor including:
a first end electrically connected to the output electrode of the eighth transistor; and
a second end electrically connected to the first electrode of the light emitting element.

23. The pixel of the display apparatus of claim 22, wherein the first to eighth transistor are N-type transistors.
